(19) United States
(12) Patent Application Publication
(10) Pub. No.: US 2007/0253217 A1
(43) Pub. Date: Nov. 1, 2007

(54) Backlight Module and a Light Diffusing Module Using the Same

(75) Inventors: Chih-Chieh Su, Hsin-Chu (TW); Chih-Kang Wu, Hsin-Chu (TW); Chung-Chuan Chen, Hsin-Chu (TW)

Correspondence Address: THOMAS, KAYDEN, HORSTEMEYER & RISLEY, LLP, 100 GALLERIA PARKWAY, NW, STE 1750, ATLANTA, GA, 30339-5948, US

(73) Assignee: AU OPTRONICS CORPORATION, Hsin-Chu (TW)

(21) Appl. No.: 11/670,642

(22) Filed: Feb. 2, 2007

(30) Foreign Application Priority Data
Apr. 28, 2006 (TW) 95115267

(51) Int. Cl. F21V 7/04

(52) U.S. Cl. 362/608; 362/257

(57) ABSTRACT

A backlight module and a light diffusing module disposed therein are provided. The light diffusing module includes a diffuser plate and an optical structure layer. The diffuser plate has a light entrance surface and a light output surface. The light entrance surface is corresponding to a light emitting surface of a light source. The light output surface of the diffuser plate includes a prickleless surface. The diffuser plate has a transmittance between 50% and 65%. The optical structure layer is disposed on the diffuser plate and includes an upper surface and a lower surface. The upper surface includes a plurality of optical structures. The lower surface of the optical structure layer directly contacts the light output surface of the diffuser plate.

### CROSS-REFERENCE TO RELATED APPLICATION

This application claims the priority benefit of Taiwanese Patent Application No. 095115267, filed on Apr. 28, 2006.

### BACKGROUND OF THE INVENTION

1. Field of the Invention

The present invention generally relates to a light diffusing module and a backlight module using the light diffusing module; particularly, the present invention relates to a light diffusing module used in a liquid crystal display (LCD) panel and a backlight module using the light diffusing module.

2. Description of the Prior Art

Backlight modules are used widely in liquid crystal display (LCD) panels, computer keyboards, buttons of cellular phones, advertising billboards, and any other devices that require a planar light source. In the recent years especially, the markets for flat panel displays are rapidly expanding. As a result, the need for LCD panels in the markets is largely increased at the same time. Furthermore, the functional and structural designs of the backlight modules used in the LCD panels have been diversified, in order to accommodate the emerging market demands for the LCD panels.

However, when a backlight module is used in a LCD panel, the illumination uniformity of the outputting light applied to the LCD panel is usually one of the important factors that affect the overall performance of the LCD panel. Along with the expansion in the size of the LCD panels, the designs of the direct-light type backlight modules have become an area highly focused by the industry. Further, creating an uniform planar light using a plurality of lamp tubes, in which the lamp tubes are disposed in parallel with one another and distributed transversely with a selected interval, while preventing the formations of partial bright spots or dark areas has become one essentiality in the designs of the backlight modules.

FIG. 1a shows one of the conventional designs of the backlight module used to provide a light source and a light diffusing module for diffusing light rays from the light source and enhancing the illumination of the LCD panel. As shown in FIG. 1a, the backlight module 10 includes a reflector plate 15 and a plurality of lamp tubes 13, in which the lamp tubes 13 are disposed in parallel with one another and distributed transversely with a selected interval. Further, a light diffusing module consists of multiple layers of components is disposed above the lamp tubes 13, wherein the components are disposed in the following order: a diffuser plate 37, a bottom diffusion sheet 35, a brightness enhancement film 31, then a top diffusion sheet or dual brightness enhancement film 33. The light rays emitted from the lamp tubes 13 will undergo a series of luminance and uniformity enhancing processes inside the light diffusing module, from traveling through the diffuser plate 37, the bottom diffusion sheet 35, the brightness enhancement film 31, and finally through the top diffusion sheet or dual brightness enhancement film 33. Thereafter, the light rays will enter a liquid crystal display (LCD) panel 50, which is disposed above the top diffusion sheet or dual brightness enhancement film 33. From the practice of this conventional design, it can be concluded that as the transmittance of the diffuser plate 37, the bottom diffusion sheet 35, and the top diffusion sheet 33 decrease, the resulting performance on diffusing the light rays will be improved. However, when their transmittance decrease, the luminous efficiency of the light source will decrease correspondingly. As a result, a higher output power must be provided for increasing the brightness of the lamp tubes 13, but this may create a high power consumption problem.

The chart in FIG. 1b shows a data analysis on the light enhancing performance of the backlight module in FIG. 1a. The light diffusing module used in the analysis consists of the diffuser plate 37 having a transmittance of 65%, the bottom diffusion sheet 35, the brightness enhancement film 31, and the dual brightness enhancement film 33. The chart shown in FIG. 1b is the distribution of the light rays after undergoing a series of luminance and uniformity enhancing processes inside the light diffusing module. In the chart, each curve corresponds to light rays having the same incidence angle upon entering the light diffusing module. Further, the horizontal axis represents the exit angle of the light ray exiting the light diffusing module, and the vertical axis represents the intensity of the exit light rays after undergoing the series of enhancing processes inside the light diffusing module. The incidence angle is defined as the angle between the incident light ray (the light ray entering the diffuser plate 37) and the normal (the line perpendicular) to the diffuser plate 37. Similarly, the exit angle is defined as the angle between the exit light ray (the light ray exiting the dual brightness enhancement film 33) and the normal to the dual brightness enhancement film 33. As shown in the chart of FIG. 1b, it is noteworthy that, for each curve, the area on the curve that corresponds to the smaller exit angles tends to have the strongest intensity of light, regardless of the incidence angles. In other words, as the emitted light rays from the lamp tubes 13 undergo a series of luminance and uniformity enhancing processes inside the light diffusing module, a large number of the light rays, regardless of their directions upon entering the light diffusing module, will be guided toward the direction perpendicular to the light diffusing module. This high concentration of light rays will hence produce a stronger intensity of light in the areas corresponding to smaller exit angles. In this situation, light rays may be directed to certain areas that are already bright enough while neglecting the gloomy areas having less light concentration, such as the areas directly above the gap between every two lamp tubes 13. As a result, the light diffusing module having this type of structure can not optimize the performance on light diffusion. Therefore, the backlight module using this light diffusing module can not enhance the illumination uniformity of the outputting light applied to the LCD panel.

### SUMMARY OF THE INVENTION

It is a primary object of the present invention to provide a light diffusing module that can enhance the uniformity of the outputting light.

It is another object of the present invention to provide a light diffusing module that can provide the outputting light at a desired level of brightness.

It is another object of the present invention to provide a backlight module that produces a uniform distribution of outputting light.

The backlight module of the present invention mainly comprises a light source and a light diffusing module. The light source has a light emitting surface, and the light diffusing module is disposed above the light source and opposite to the light emitting surface of the light source. The light source preferably includes a reflector plate and at least one lamp tube. The light emitted from the lamp tubes and the light reflected by the reflector plate will enter the light diffusing module through the light emitting surface.

The light diffusing module mainly comprises a diffuser plate and an optical structure layer. The diffuser plate has a light entrance surface and a light output surface. The light entrance surface is opposite to the light emitting surface of the light source, and the light output surface is a prickleless surface. When light rays are emitted from the lamp tubes of the light source, the rays of light will enter the diffuser plate through the light entrance surface of the diffuser plate. In the preferred embodiment, the transmittance of the diffuser plate is between 50% to 65%, while the thickness of the diffuser plate is preferably between 1.5 mm to 2.0 mm.

The optical structure layer is disposed above the diffuser plate, and it has an upper surface and a lower surface. The upper surface includes a plurality of optical structures. The lower surface of the optical structure layer is directly overlaid to the light output surface of the diffuser plate. In the preferred embodiment, the optical structure layer is a prism sheet.

In the preferred embodiment, the light diffusing module further comprises an optical film. The optical film is disposed above the optical structure layer and covers the upper surface of the optical structure layer. The optical film in this embodiment is not a prism sheet. It can be a dual brightness enhancement film (DBEF) that consists of multiple layers of optical sheets. On the other hand, it can also be a diffusion sheet. The optical structure layer is sandwiched between the diffuser plate and the optical film. Furthermore, it can be damaged easily, which is often associated with contact or friction with the sharp protruding surface of the neighboring component, thereby resulting scratches on the optical structure layer. Therefore, the light output surface of the diffuser plate needs to have a prickleless surface, in order to prevent damaging the optical structure layer.

### BRIEF DESCRIPTION OF THE DRAWINGS

FIG. 1a is a cross-sectional view of the conventional backlight module and the conventional liquid crystal display (LCD) panel;

FIG. 1b is a chart illustrating the light diffusion performance of the conventional backlight module in FIG. 1a;

FIG. 2 is a perspective view of the backlight module and the LCD panel of the present invention;

FIG. 3 is a cross-sectional view showing an embodiment of the backlight module of the present invention;

FIG. 4 is a cross-sectional view showing another embodiment of the backlight module of the present invention;

FIG. 5 is a chart illustrating the light diffusion performance of the backlight module in an embodiment of the present invention.

### DETAILED DESCRIPTION OF THE PREFERRED EMBODIMENT

The present invention provides a light diffusing module and a backlight module using the light diffusing module. In the preferred embodiment, the backlight module is used in a liquid crystal display (LCD) panel. In a different embodiment, however, the backlight module can be used in a computer keyboard, buttons of cellular phones, an advertising billboard, and any other device that requires a planar light source. In addition, the present invention further includes a LCD panel using the light diffusing module. In the preferred embodiment, the LCD panel of the present invention includes a color LCD panel. However, in a different embodiment, the LCD panel of the present invention may include a monochrome LCD panel. The LCD device is generally referring to the display device that constitutes a LCD panel. This may include a home LCD television, the computer LCD monitor for a personal computer or a laptop computer, and the LCD screen for a cellular phone or a digital camera.

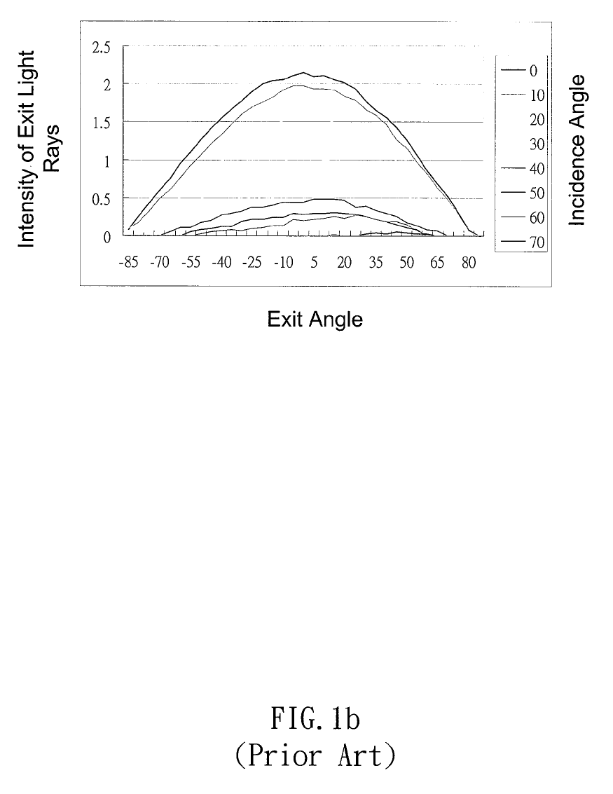

As shown in FIG. 2, the backlight module of present invention mainly comprises a light source 100 and a light diffusing module 300, and a liquid crystal display (LCD) panel 500 is disposed above the backlight module. The light source 100 has a light emitting surface 110 and preferably includes lamp tubes 130 and a reflector plate 150. In the embodiment shown in FIG. 2, the light source 100 can be an immediate beneath type (OR direct-light type) light source. However in a different embodiment, the light source 100 can be an edge-light type light source. The light rays emitted out from the light source 100 exit the light source 100 from the light emitting surface 110. Further, in a different embodiment, the lamp tube 130 of the light source 100 can be replaced by a different light device, such as a light emitting diode (LED), etc.

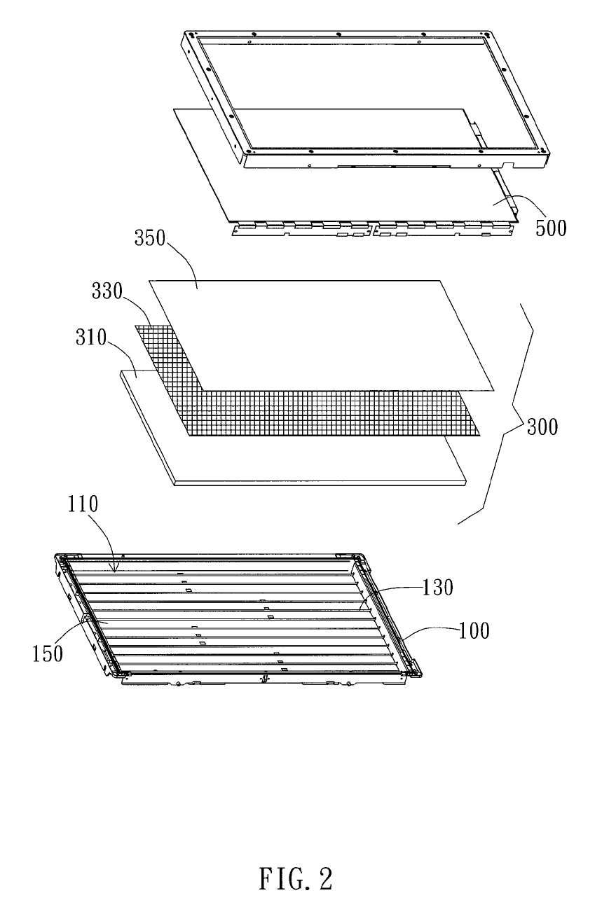

As shown in FIG. 3, the light diffusing module 300 is disposed opposite to the light emitting surface 110 of the light source 100 and is preferably disposed directly above the light source 100. The light diffusing module 300 mainly comprises a diffuser plate 310 and an optical structure layer 330. In the preferred embodiment, the diffuser plate 310 is made out of polystyrene (PS). In a different embodiment, the diffuser plate 310 can be made out of other organic materials, such as polycarbonate (PC) and cyclo olefin polymer (COP).

The diffuser plate 310 has a light entrance surface 313 and a light output surface 311, wherein the light entrance surface 313 is opposite to the light emitting surface 110 of the light source 100. In the embodiment shown in FIG. 3, the light entrance surface 313 covers on top of the light emitting surface 110 of the light source 100. The light output surface 311 includes a prickleless surface, and this prickleless surface is preferably a smooth surface. When the light rays are emitted out from the lamp tubes 130 of the light source 100, the light rays will enter the diffuser plate 310 through the light entrance surface 313 of the diffuser plate 310. As the light rays reach the diffuser plate 310, part of the light rays will be reflected and refracted by the particles dispersed inside the diffuser plate 310. Thereafter, these light rays will exit the diffuser plate 310 from the light output surface 311 in directions different from the incident directions that they take while entering the diffuser plate 310. Hence, the rays of light emitted from the light source 100 are diffused by the diffuser plate 310.

In the preferred embodiment, the diffuser plate 310 has a transmittance between 50% to 65% and a thickness preferably between 1.5 mm to 2.0 mm. The light diffusing module 300 has a better diffusion performance when the diffuser plate 310 has a transmittance of 60% accompanies by a thickness of 1.5 mm. On the other hand, the light diffusing module 300 has a better diffusion performance when the diffuser plate 310 has a transmittance of 65% accompanies by a thickness of 2.0 mm.

As shown in FIG. 3, the optical structure layer 330 is disposed above the diffuser plate 310, and it has an upper surface 331 and a lower surface 333. The upper surface 331 includes a plurality of optical structures 335. In the preferred embodiment, the plurality of optical structures 335 are prisms fabricated on the upper surface of the optical structure layer 330, and it is preferred to use an optical thin film fabrication or other methods to prepare the upper surface 331 of the optical structure layer 330. The optical thin film fabrication mentioned here includes etching, lithography, coating, etc. In a different embodiment however, the optical structures 335 can be developed on the upper surface 331 by affixing or other methods.

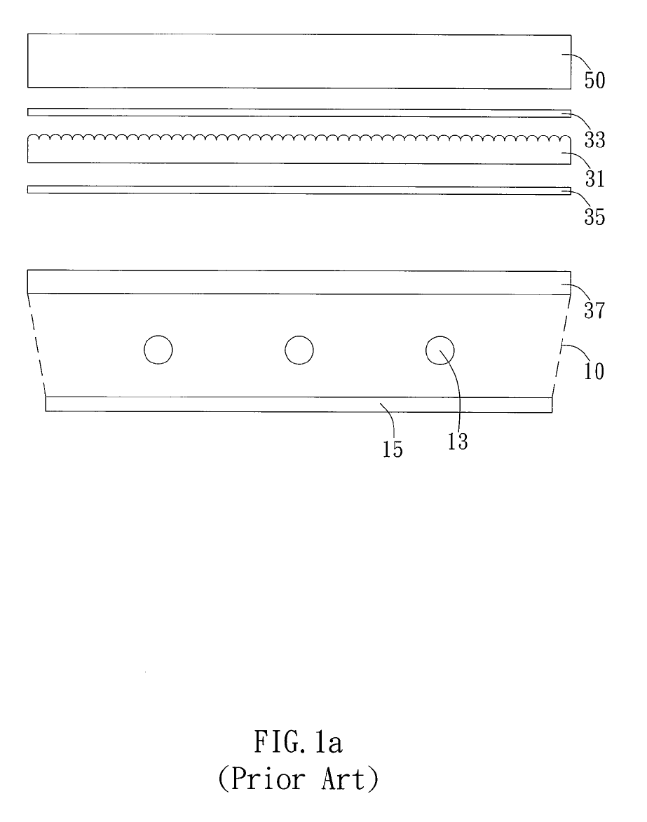

The lower surface 333 of the optical structure layer 330 is directly overlaid to the light output surface 311 of the diffuser plate 310. In other words, there are no other optical films, such as the bottom diffusion sheet 35 from the conventional design of the backlight module shown in FIG. 1a, disposed between the lower surface 333 of the optical structure layer 330 and the diffuser plate 310. In the preferred embodiment, the optical structure layer 330 is directly laid on top of the diffuser plate 310. Due to the direct contact of the diffuser plate 310 to the optical structure layer 330, the light diffusing module 300 of the present invention is able to produce a better illumination uniformity result.

In the preferred embodiment, the optical structure layer 330 is a brightness enhancement film (BEF), and is preferably a prism sheet. The optical structure layer 330 is preferably made out of polyethylene terephthalate (PET). In a different embodiment, the optical structure layer 330 can be made out of other organic material, such as polycarbonate, etc. The optical structure 335 developed on the upper surface 331 of the optical structure layer 330 is preferably made out of polymethyl methacrylate (PMMA). In a different embodiment however, the optical structure 335 can be made of other acrylic resin.

In the preferred embodiment shown in FIG. 3, the light diffusing module 300 further includes an optical film 350. The optical film 350 is disposed above the optical structure layer 330 and covers the upper surface 331 of the optical structure layer 330. In the preferred embodiment, the optical film 350 is a dual brightness enhancement film (DBEF). In a different embodiment, however, the optical film 350 can be a diffusion sheet. The optical film 350 is preferably made out of polyethylene terephthalate (PET). In a different embodiment, however, the optical film 350 can be made out of other organic material, such as polycarbonate, etc.

As shown in FIG. 3, the optical structure layer 330 is sandwiched between the diffuser plate 310 and the optical film 350. The optical structure layer 330 can be damaged easily, which is often associated with contact or friction with the sharp protruding surface of the neighboring component, thereby resulting scratches on the optical structure layer. Therefore, the light output surface 311 of the diffuser plate 310 needs to have a prickleless surface to prevent damaging the optical structure layer 330. Furthermore, the optical film 350 can also act as a protective layer for reducing damages on the optical structure layer 330.

When the light rays emit from the light output surface 311 of the diffuser plate 310, the rays will immediately enter the optical structure layer 330 overlaid to the diffuser plate 310. The optical structures 335 fabricated on the optical structure layer 330 will redirect the rays of light and thereby increase the outputting luminance of the light. At the same time, the optical structures 335 are able to help diffusing the light rays, hence enhance the uniformity of light distribution for the light diffusing module 300. Thereafter, the light rays outputting from the optical structure layer 330 will enter the optical film 350, wherein the light rays will once again undergo a luminance enhancing process or a light diffusing process. Afterward, the outputting light rays will arrive the LCD panel.

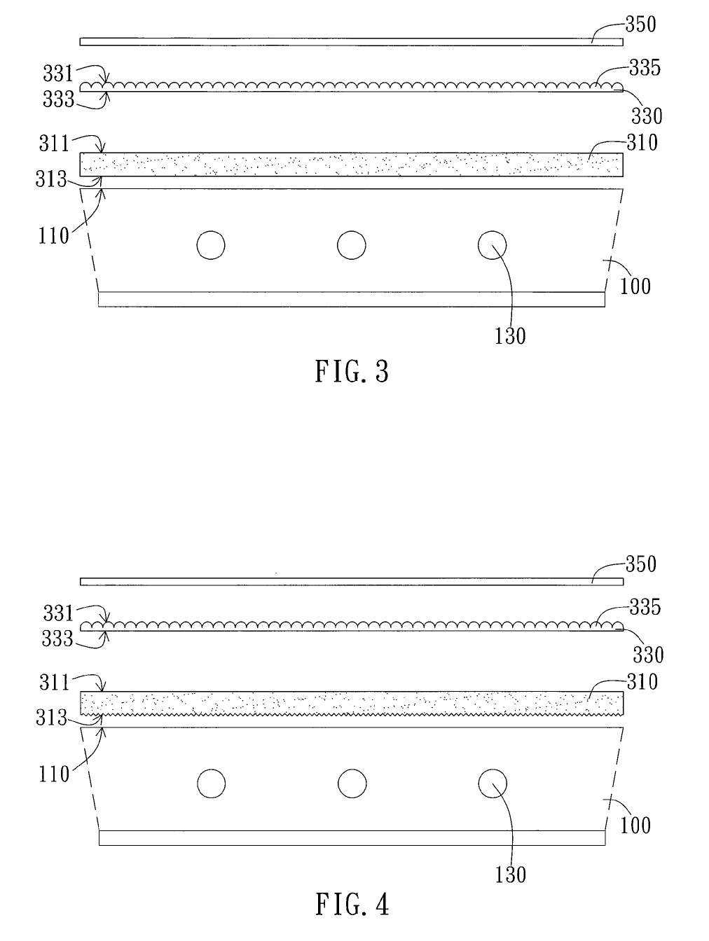

FIG. 4 is another embodiment of the present invention. In this embodiment, the light entrance surface 313 of the diffuser plate 310 is a rough surface. Through this rough optical structure, the light diffusion performance of the light diffusing module 300 can be further enhanced. In a different embodiment, this rough surface can be fabricated on the light output surface 311 of the diffuser plate 310. However, the rough surface must not contain any sharp protrusion, in order to prevent damaging the optical structure layer 330.

In the conventional designs, a common perception on diffuser plates in general is that having a lower transmittance will produce a better light diffusion performance for the diffuser plate. However, in the present invention, when the optical structure layer 330 is directly overlaid to the diffuser plate 310 having a transmittance between 50% to 65%, the overall light diffusion performance of the light diffusing module 300 can be optimized. Since the transmittance of the diffuser plate 310 is rather high to a certain extent, the amount of light from the light source 100 that is effectively used, for providing light to the backlight module, remains in a reasonable amount. Furthermore, the power consumption is decreased because the need for increasing the brightness of the lamp tubes 130 is greatly reduced in this case.

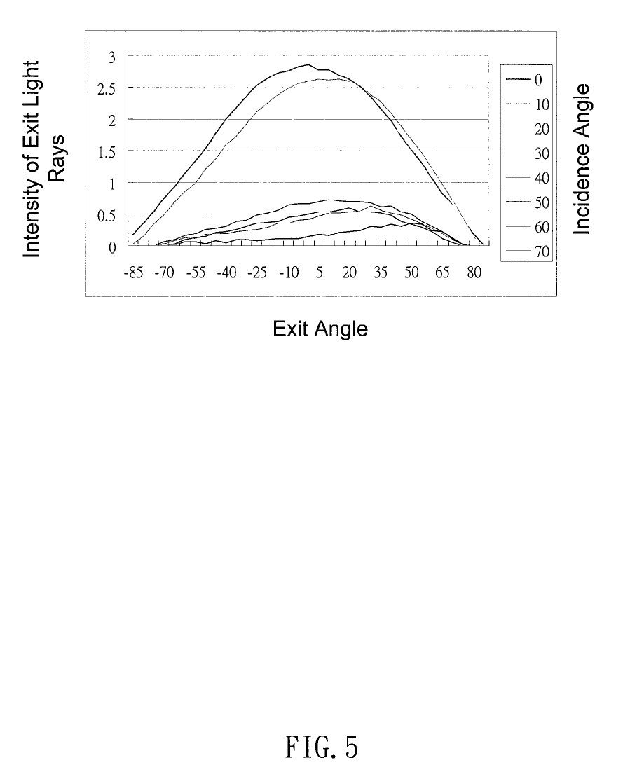

The chart in FIG. 5 shows a data analysis on the light enhancing performance of the present invention in one embodiment. In the light diffusing module 300 of this embodiment, the diffuser plate 310 has a transmittance of 65%, the optical structure layer 330 directly overlaid to the diffuser plate 310 is a brightness enhancement film (BEF) having multiple optical structures of prisms, and the optical film 350 disposed above the optical structure layer 330 is a dual brightness enhancement film (DBEF). The chart in FIG. 5 is the distribution of the light rays after undergoing a series of luminance and uniformity enhancing processes inside the light diffusing module 300. In the chart, each curve corresponds to light rays having the same incidence angle upon entering the light diffusing module 300. Further, the horizontal axis represents the exit angle of the light ray exiting the light diffusing module 300, and the vertical axis represents the intensity of the exit light rays after undergoing the series of enhancing processes inside the light diffusing module 300. The incidence angle is defined as the angle between the incident light ray (the light ray entering the diffuser plate 310) and the normal (the line perpendicular) to the diffuser plate 310. Similarly, the exit angle is defined as the angle between the exit light ray (the light ray exiting the optical film 350) and the normal to the optical film 350. Compared this analysis chart to the chart in FIG. 1b, it is noteworthy that as the incidence angles of the light rays increase, the exit angles of the light rays will also increase correspondingly. Unlike the situation in the conventional design of the backlight module in FIG. 1a, where the majority of the light rays will be guided toward the perpendicular direction, in the backlight module of the present invention, the non-perpendicular light rays entering the light diffusing module 300 will scatter in non-perpendicular directions also as they exit the light diffusing module. Hence, the light rays are able to reach some of the gloomy areas, such as the areas directly above the gap between every two lamp tubes 130. In other words, the light rays emitted from the lamp tubes 130 can be diffused uniformly, reducing the problem of having high concentration of light in certain areas while leaving some other areas dark or gloomy. As a result, the present invention is able to provide a light diffusing module producing a uniform light distribution.

Although the preferred embodiments of the present invention have been described herein, the above description is merely illustrative. Further modification of the invention herein disclosed will occur to those skilled in the respective arts and all such modifications are deemed to be within the scope of the invention as defined by the appended claims.

We claim:

1. A light diffusing module, for using in combination with a light source, comprising:
a diffuser plate comprising a light entrance surface and a light output surface, wherein the light output surface is opposite to the light entrance surface and includes a prickleless surface, and the diffuser plate has a transmittance approximately between 50% to 65%; and
an optical structure layer disposed above the diffuser plate and having a lower surface and an upper surface, wherein the lower surface is overlaid to the light output surface of the diffuser plate directly, and the upper surface includes a plurality of optical structures.

2. The light diffusing module according to claim 1, wherein the light output surface of the diffuser plate includes a smooth surface.

3. The light diffusing module according to claim 1, wherein the thickness of the diffuser plate is approximately between 1.5 mm to 2.0 mm.

4. The light diffusing module according to claim 3, wherein the thickness of the diffuser plate is approximately 1.5 mm, and the transmittance of the diffuser plate that corresponds to this thickness is approximately 60%.

5. The light diffusing module according to claim 3, wherein the thickness of the diffuser plate is approximately 2.0 mm, and the transmittance of the diffuser plate that corresponds to this thickness is approximately 50%.

6. The light diffusing module according to claim 1, wherein the optical structure layer includes a brightness enhancement film (BEF).

7. The light diffusing module according to claim 1, wherein the optical structure layer includes a prism sheet.

8. The light diffusing module according to claim 1, wherein the light diffusing module further includes an optical film disposed above the optical structure layer, wherein the optical film covers the upper surface of the optical structure layer.

9. The light diffusing module according to claim 8, wherein the optical film is a non-prism sheet.

10. The light diffusing module according to claim 8, wherein the optical film includes a diffusion sheet.

11. The light diffusing module according to claim 8, wherein the optical film includes a dual brightness enhancement film (DBEF).

12. A backlight module, comprising:
a light source comprising a light emitting surface; and
a light diffusing module disposed corresponding to the light emitting surface, wherein the light diffusing module comprising:
a diffuser plate comprising a light entrance surface and a light output surface, wherein the light output surface is opposite to the light entrance surface and includes a prickleless surface, and the diffuser plate has a transmittance approximately between 50% to 65%; and
an optical structure layer disposed above the diffuser plate and comprising a lower surface and an upper surface, wherein the lower surface is overlaid to the light output surface of the diffuser plate directly, and the upper surface includes a plurality of optical structures.

13. The backlight module according to claim 12, wherein the light output surface of the diffuser plate includes a smooth surface.

14. The backlight module according to claim 12, wherein the thickness of the diffuser plate is approximately between 1.5 mm to 2.0 mm.

15. The backlight module according to claim 14, wherein the thickness of the diffuser plate is approximately 1.5 mm, and the transmittance of the diffuser plate that corresponds to this thickness is approximately 60%.

16. The backlight module according to claim 14, wherein the thickness of the diffuser plate is approximately 2.0 mm, and the transmittance of the diffuser plate that corresponds to this thickness is approximately 50%.

17. The backlight module according to claim 12, wherein the optical structure layer includes a brightness enhancement film (BEF).

18. The backlight module according to claim 12, wherein the optical structure layer includes a prism sheet.

19. The backlight module according to claim 12, wherein the light diffusing module further includes an optical film disposed above the optical structure layer, wherein the optical film covers the upper surface of the optical structure layer.

20. The backlight module according to claim 19, wherein the optical film is a non-prism sheet.

21. The backlight module according to claim 19, wherein the optical film includes a diffusion sheet.

22. The light diffusing module according to claim 19, wherein the optical film includes a dual brightness enhancement film (DBEF).
